(19) United States
(12) Patent Application Publication
(10) Pub. No.: US 2026/0211964 A1
(43) Pub. Date: Jul. 23, 2026

(54) SEARCH SYSTEM AND PROGRAM

(71) Applicant: Socialis Co.,Ltd., Osaka (JP)

(72) Inventors: Hideki TOMINAGA, Osaka (JP); Tomoyuki TSUJIMOTO, Osaka (JP); Masaki TOMINAGA, Osaka (JP); Shuhei NOJIMA, Osaka (JP); Mao ADACHI, Osaka (JP); Yasuyuki NAGATSUKA, Osaka (JP)

(21) Appl. No.: 19/570,150

(22) Filed: Mar. 18, 2026

Related U.S. Application Data
(63) Continuation of application No. PCT/JP2024/042594, filed on Dec. 2, 2024.

(30) Foreign Application Priority Data
Dec. 1, 2023 (JP) 2023-204289

(51) Int. Cl. G06F 16/9538

(52) U.S. Cl. CPC G06F 16/9538

(57) ABSTRACT

A search system displays an entering page for search word on the client terminal, when the search word entered in the entering page is received at a server device connected to the client terminal via the Internet, a search engine provided in the server device performs a search. When the search results by the search engine are received at the client terminal, a search result display page for displaying the search results is displayed on the client terminal. The search engine is configured to perform at least a normal search that searches for related information related to the search word and a different aspect search that searches for different aspect information related to a different word derived from the search word but having a different meaning from the search word. On the search result display page, the results of the normal search and the different aspect search are simultaneously displayed.

### CROSS-REFERENCE TO RELATED APPLICATIONS

This Application claims the benefit of priority and is a Continuation application of the prior International Patent Application No. PCT/JP2024/042594, with an international filing date of Dec. 2, 2024, which designated the United States, and is related to the Japanese Patent Application No. 2023-204289, filed Dec. 1, 2023, the entire disclosures of all applications are expressly incorporated by reference in their entirety herein.

### TECHNICAL FIELD

The present disclosure relates to a search system and the like used for searching information on the Internet.

### BACKGROUND ART

Search systems are used to find information that users seek from a vast amount of data on the Internet. In a search system, a search word (search queries) entered into a search box of a client terminal's browser is sent to a server device. A search engine operating in the server device then performs a search using the search word. The search results by the search engine are sent from the server device to the client terminal and displayed on the browser of the client terminal (e.g., Patent Document 1).

### PRIOR ART TECHNICAL DOCUMENT

### Patent Document

[Patent Document 1] Japanese Patent Publication No. 6790942

### DESCRIPTION OF THE DISCLOSURE

### Problem(s) to be Solved by the Disclosure

Incidentally, conventional search systems such as Google (registered trademark) can only lead to web pages and information highly relevant to the search word. Consequently, gaining new insights is difficult. While this is no problem with users who look up word meanings and so forth, it is hardly useful when gaining new insights is beneficial (e.g., when conducting a search for product development or marketing).

The present disclosure was made in light of these circumstances and aims to realize a search system that enables users of client terminals to encounter information they never thought of.

### Means for Solving the Problems

To address the aforementioned problems, the first invention is a search system comprising: a search engine provided in a server device; and a view processing portion provided in a client terminal, wherein the search engine is configured to perform searches when a search word received at the server device from the client terminal via the Internet; wherein when results the searches by the search engine are received at the client terminal, the view processing portion causes the client terminal to display a search result display page for displaying the results of the searches; wherein the search engine is configured to perform at least a normal search that searches for related information related to the search word and a different aspect search that searches for different aspect information related to a different word derived from the search word, the different word having a meaning different from the search word; and wherein the view processing portion causes the client terminal to simultaneously display the results o the normal search and the results of the different aspect search on the search result display page.

The second invention is that in the first invention, the different aspect search is a serendipity search that searches for serendipity information that a user of the client terminal perceives as serendipitous, using a serendipity-search obtained based on a related word related to the search word as the different word; wherein the search engine is configured to perform, in addition to the normal search and the serendipity search, an objective information search that searches at least two or more databases from among a semantic dictionary database, a thesis database, a book database and a newspaper article database, using the search word; and wherein the results of the normal search, the results of the serendipity search and the results of the objective information search are simultaneously displayed on the search result display page.

The third invention that in the first invention, information of plural web pages as the respective search results of the normal search and the different aspect search are displayed on the search result display page; wherein when an operation is performed on the client terminal to select one of the plural web pages, the selected web page is viewably displayed on the client terminal; wherein when an operation is performed on the client terminal to select a comparison mode, icons of plural web pages viewed on the client terminal are arranged and displayed in a predetermined order on the client terminal; and wherein when an operation is performed to select the plurality of icons as part of the icons of the plural web pages, the web pages of the selected plural icons are viewably displayed side-by-side vertically or horizontally.

The fourth invention is that in the first invention, information of plural web pages as the respective search results of the normal search and the different aspect search are displayed on the search result display page; wherein when an operation is performed on the client terminal to select one of the plural web pages, the selected web page is viewably displayed on the client terminal; wherein, in a state where the web page is viewably displayed on the client terminal, when an operation to select a concreteness-abstraction mode is performed on the client terminal, the system is configured to automatically acquire an abstract word and a concrete word by using a target word which is a word related to the web page viewably displayed and perform an abstract search using the abstract word and a concrete search using the concrete word, the abstract word is obtained by higher-level conceptualizing the target word and the concrete word is obtained by lower-level conceptualizing the target word; and wherein the search results of the abstract search and the search results of the concrete search are arranged and displayed on the client terminal in an order of an abstractness of the search word.

The fifth invention is that in the second invention, identification information is displayed on the search result display page to enable the user of the client terminal to distinguish between the results of the normal search, the results of the serendipity search and the results of the objective information search.

The sixth invention is that in the second invention, when a scrolling operation is performed on the search result display page, the results of the normal search, the results of the serendipity search and the results of the objective information search scroll simultaneously.

The seventh invention is that in the second invention, a selecting operation is possible to narrow down plural types of search results, including the results of the normal search, the results of the serendipity search and the results of the objective information search to one type of search results for viewing on the search result display page; and wherein when the selecting operation is performed, a narrowed-down view page displaying only the one type of search results selected by the selecting operation from among the plural types of search results is displayed on the client terminal.

The eighth invention is that a non-transitory computer-readable information storage medium storing a search program for causing a computer of a server device to: perform, as an operation of a search engine, at least a normal search that searches for information related to a search word and a different aspect search that searches for different aspect information related to a different word derived from the search word, when the search word is received at the server device from a client terminal, the different word having a meaning different from the search word; and transmit information containing results of the normal search and results the different aspect search to the client terminal that transmitted the search word.

The ninth invention is a non-transitory computer-readable information storage medium storing a program for causing a computer of a client terminal to: transmit a search word received from a user of the client terminal to a server device where a search engine operates; transition a monitor display of the client terminal to a search result display page simultaneously displaying results of a normal search composed of related information related to the search word and results of a different aspect search composed of different aspect information related to a different word derived from the search word, when information containing the results of the normal search and the results of the different aspect search are received at the client terminal from the server device, the different word having a meaning different from the search word. [Effect of the Disclosure]

In the present disclosure, the search engine performs not only a normal search to find information related to a search word, but also a different aspect search for searching for different aspect information using a different word derived from the search word and having a different meaning. On the search result display page displayed on the client terminal, both the results of the normal search and the different aspect search are simultaneously displayed. Consequently, the user of the client terminal can view not only the normal search results but also the different aspect search results, enabling the users to encounter information that they might not have otherwise thought of.

### BRIEF DESCRIPTION OF THE DRAWINGS

FIG. 1 is a schematic configuration diagram of a search system according to the present embodiment.

FIG. 2 is a diagram showing an entering page.

FIG. 3 is a flowchart showing an example of process flow of a search unit.

FIG. 4 is a flowchart showing an example of process flow of a view processing unit.

FIG. 5 is a diagram showing a search result display page.

FIG. 6 is a diagram explaining a method for arranging search results.

FIG. 7 is a diagram of explaining of forward scrolling on the search result display page.

FIG. 8 is a diagram of explaining backward scrolling on the search result display page.

FIG. 9 is a diagram showing the narrowed-down view page.

FIG. 10 is a diagram showing a positioning map.

FIG. 11 is a schematic configuration diagram of a search system according to the first modified example of the present embodiment.

FIG. 12 is a flowchart showing an example of process flow of a search unit according to the first modified example.

FIGS. 13A and 13B are diagrams showing a latest information display page according to the second modified example, and FIG. 13C is a diagram showing a resource display page.

FIG. 14A is a diagram showing a search word entering page, and FIG. 14B is a diagram showing a search result display page.

FIGS. 15A to 15D are diagrams showing transition of a comparative-viewing preparation page, and FIGS. 15E and 15F are diagrams showing the state where plural resource display pages 52 are displayed simultaneously.

FIGS. 16A to 16D are diagrams showing transition from a resource display page to a second search result display page.

FIGS. 17A to 17D are diagrams showing transition from a resource display page to a third search result display page.

FIGS. 18A to 18C are diagrams showing transition from a resource display page to a site information display page.

### MODES FOR CARRYING OUT THE DISCLOSURE

The embodiment of the present disclosure will be described in detail by referring to the drawings. Note that the following embodiment is merely an example of the present disclosure, and is not intended to be limiting the present disclosure, its application or the scope of application of the present disclosure.

### [Search System Overview]

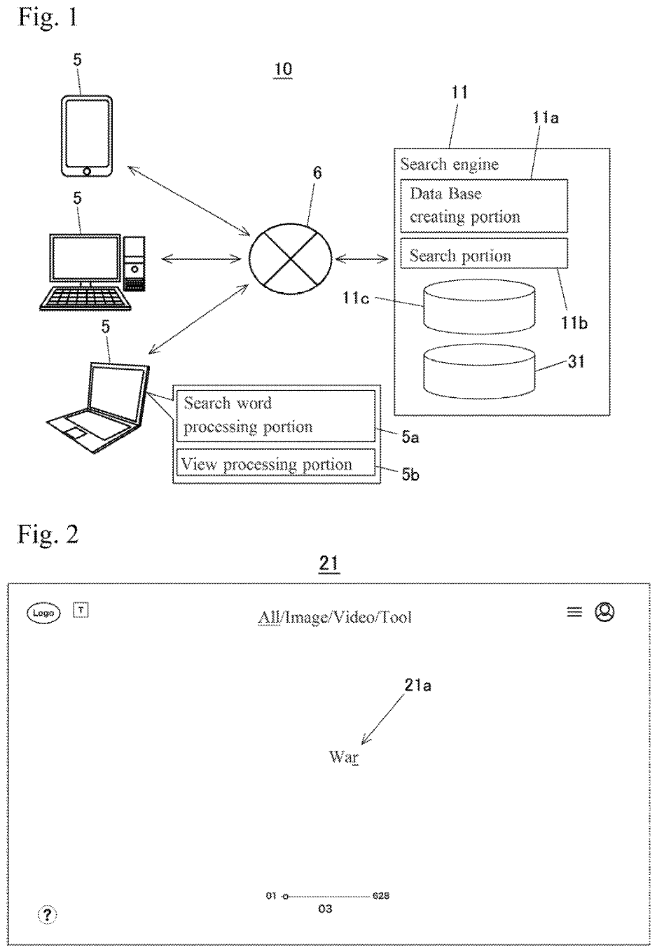

A search system 10 is a web search system used to search for information (resources) such as web pages, documents (thesis, articles, etc.), images, and videos assigned URLs (Uniform Resource Locators), etc. on the Internet 6. The search system 10 has a server device 11 connected to a client terminal 5 via the Internet 6 (see FIG. 1).

A server device 11 has a search program installed that realizes a search engine. In the server device 11, a CPU (processor) executes and interprets the search program so that the search engine operates thereby realizing, as functional blocks, a database creation unit 11a and a search unit 11b. In the database creation unit 11a, a crawler cruises through the Internet 6 and collects resource information, while an indexer creates an index (database) 11c from the resource information. When a search word (search query) arrives from the client terminal 5, the search unit 11b searches an index 11c and outputs the search results to the client terminal 5 that transmitted the search word. These search results (transmitted information) contain list information (list information of resources) such as web pages with respect to the respective three types of search results described later.

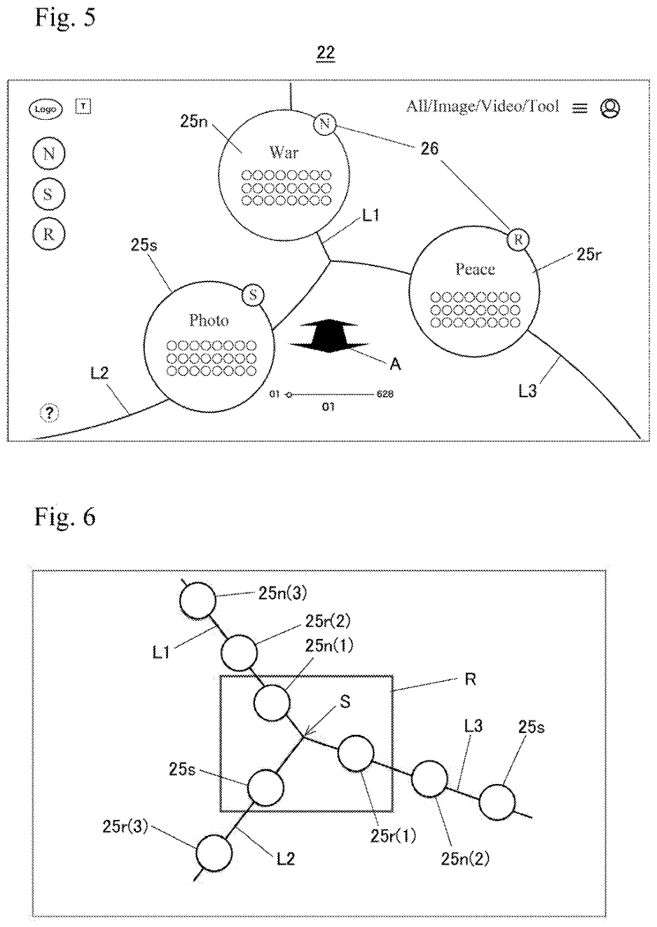

The client terminal 5 has a client program installed that enables entering a search word and viewing search results by the search engine. On the client terminal 5, the CPU (processor) executes and interprets the client program to realize, as functional blocks, a search word processing unit 5a and a view processing unit 5b. The search word processing unit 5a displays a search word entering page 21 (see FIG. 2) on the client terminal 5. Upon receipt of operation by the user of the client terminal 5 to execute a search, it transmits the search word entered into a search window 21a of an entering page 21 to the server device 11. Upon receipt of the aforementioned transmitted information from the server device 11, the view processing unit 5b displays a search result display page 22 (see FIG. 5) on the monitor of the client terminal 5 to show the search results. Note that the client program may operate on the client terminal 5 or in a cloud.

### [Search Engine]

In the present embodiment, processing performed by the search unit 11b (processing by the search engine) enables multifaceted searching of a subject. The search unit 11b is configured to execute three types of searches upon receipt of a search word from the client terminal 5. The search unit 11b provides unbiased search results for any of the three types of searches. The three types of searches are a normal search, a serendipity search (first different aspect search) and a reverse search (second different aspect search).

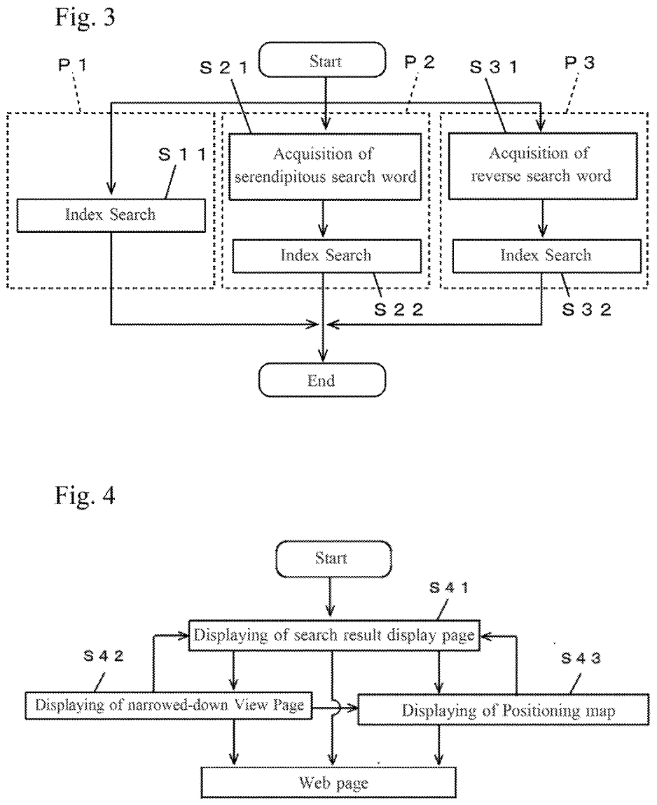

FIG. 3 is an example of process flow of the search unit 11b. When a search word arrives from the client terminal 5, the search unit 11b starts its process flow and performs a normal search process P1, a serendipity search process P2 and a reverse search process P3 in parallel.

The normal search searches for relevant information (relevant resource) related to the search word from the information accumulated in the index 11c. In the normal search process P1, an index search S11 is performed, using the search word directly as a word for searching by the index 11c.

The serendipity search searches information stored in the index 11c for serendipity information (different aspect resource) that the user of the client terminal 5 perceives as serendipitous, using a serendipitous search word (different word) obtained based on a related word related to the search word. In the process P2 of the serendipity search, a serendipitous search word acquisition S21 of acquiring a serendipitous search word from a search word and an index search S22 of using the serendipitous search word as a search word for the index 11c are performed in this order.

Regarding a method for acquiring a serendipitous search word, after acquiring a related word (primary related word) related to a search word, the search unit 11b performs a process in the step S21 for acquiring a secondary related word related to the primary related word as a serendipitous search word. For example, if the search word is “war,” the candidate primary related word includes “dispute,” “politics,” “history,” “life” and “history/journalism”. If “history/journalism” is acquired as the primary related word from these candidates, the secondary related word “photography” related to “history/journalism” is acquired as the serendipitous search word. Further, if “dispute” is acquired as the primary related word, the secondary related word “family court” related to “dispute” is acquired as the serendipitous search word. Note that in the serendipitous search word acquisition step S21, the serendipitous search word may be acquired by another process such as directly acquiring a related word (primary related word) related to a search word as a serendipitous search word.

Regarding a method for acquiring a related word in the step S21, for example, a semantic dictionary database (language dictionary database) 31 is provided in advance in the server device 11, so that the search unit 11b performs a meaning search on the search word in the semantic dictionary database 31, thereby acquiring a primary related word related to the search word in the semantic dictionary database 31. Then, the search unit 11b performs a meaning search on the primary related word in the semantic dictionary database 31, thereby acquiring a secondary related word related to the primary related word in the semantic dictionary database 31.

Note that the semantic dictionary database 31 is a database compiling the meanings of numerous words (such as vocabulary), sets of words (such as vocabulary) in synonymic relationships (i.e., groups of word concepts), definition sentences and example sentences. In the respective sets of words in synonymic relationships, the words are linked by diverse relationships such as superordinate-subordinate, synonymous, similar, or antonymous relationships. As the semantic dictionary database 31, for example, a database called “WordNet” can be used. The Japanese WordNet was created by the National Institute of Information and Communications Technology (NICT), and Word Nets for various languages worldwide have also been developed. The semantic dictionary database 31 may also be composed of thesaurus dictionary data. Further, when searching for meanings in the semantic dictionary database 31 yields plural candidate related words (secondary related words), one candidate can be randomly selected as the related word using a random number and the like. However, when plural candidate related words exist, a single candidate may also be selected as the related word using a predetermined algorithm.

Note that in the semantic dictionary database 31, a word obtained by abstraction, higher-level conceptualization, concretization or elemental decomposition of a search target word (search word, primary related word) is recorded as related word corresponding to the search target word the meaning of which is searched in the semantic dictionary database 31. For example, if a search target word is “apple,” the related word includes “fruit” and “nutrition”. If a search target word is “fruit,” “fertilizer” becomes one of the related words. If a search target word is “nutrition,” “vitamin” becomes one of the related words. If a search target word is “war,” “part of history” becomes one of the related words. If a search target word is “part of history,” “photograph” becomes one of the related words. Note that these are merely examples of related words.

The reverse search uses a reverse search word (different word) having a meaning opposite (antithetical) to a search word to search for reverse information (different aspect resource) from the stored information in the index 11c. In the reverse search process P3, a reverse search word acquisition step S31 for acquiring a reverse search word from a search word and an index search S32 for using the acquired reverse search word as a search word in the index 11c are performed in this order. Note that regarding a method for acquiring a reverse search word, in the step S31, the search unit 11b performs a search of the aforementioned semantic dictionary database 31 and acquires a reverse search word corresponding to the search word. However, the method for acquiring a reverse search word is not limited to this process. Note that if no reverse search word to a search word exists, the reverse search is not performed.

### [Client Terminal]

The monitor display of the client terminal 5 transitions by processing of a client-specific program or a program running on a web browser. Specifically, the monitor display of the client terminal 5 starts from an entering page 21 shown in FIG. 2. When the user of the client terminal 5 performs the operations of entering a search word and executing a search, transmitted information containing the search results from the search engine arrives from the server device 11. Then, the view processing unit 5b performs a process in accordance with the flowchart shown in FIG. 4.

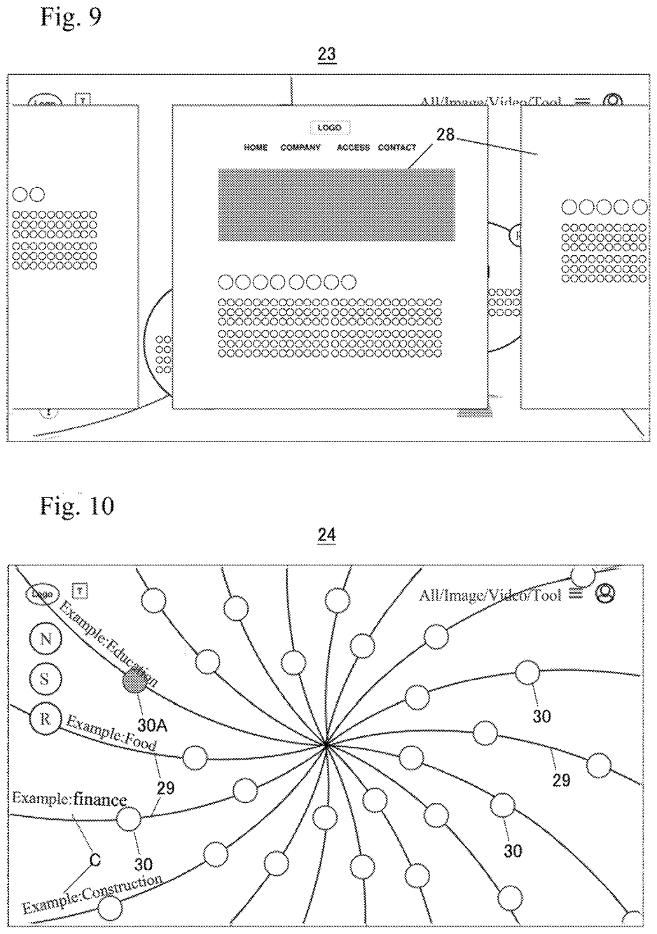

When the search results by the search engine arrive, the view processing unit 5b conducts a display S41 on the search result display page 22 shown in FIG. 5. Further, when a predetermined operation (a selecting operation described later) is performed on the search result display page 22, the view processing unit 5b conducts a display S42 of a narrowed-down view page shown in FIG. 9. Alternatively, when another predetermined operation is performed on the search result display page 22, it conducts a display S43 of a positioning map 24 shown in FIG. 10. On the narrowed-down view page 23, too, if a predetermined operation (map transition operation described later) is performed, it conducts a display S43 of a positioning map 24 shown in FIG. 10. Further, when the user clicks a link portion to a web page on the search result display page 22, on the narrowed-down view page 23 or on the positioning map 24, the view processing unit 5b transitions to the web page.

On the search result display page 22, the search results of the above-mentioned three types of searches (results of the normal search, results of the serendipity search and results of the reverse search) are simultaneously displayed. Each type of the search results is composed of information (list information) about a large number of web pages, etc. (resources). For at least the respective results of the normal search and the reverse search from among the three types of the search results, the aforementioned list information includes search ranking information.

As shown in FIG. 5, information on each web page, etc. (resource) is displayed inside display frames 25n, 25s and 25r having a predetermined shape (such as circular). Here, a symbol 25n represents a display frame for a web page, etc., included in the results of a normal search, a symbol 25s represents a display frame for a web page, etc., included in the results of a serendipity search and a symbol 25r represents a display frame for a web page, etc., included in the results of a reverse search. Further, identification information 26 indicating which of the three types of search results each display frame 25n, 25s, 25r corresponds to is added. In the present embodiment, the identification information 26 labeled “N” is attached to the results of a normal search, the identification information 26 labeled ‘S’ is attached to the results of a serendipity search and the identification information 26 labeled “R” is attached to the results of a reverse search. Inside the display frames 25n, 25s and 25r, for example, title information of web pages, etc. and part of posted information of web pages, etc. are displayed. The display frames 25n, 25s and 25r contain link information (for example URLs) to the web pages, etc. By clicking the inside of the display frames 25n, 25s or 25r, the user can access the web pages, etc.

Next, scrolling on the search result display page 22 will be described. On the search result display page 22, three types of search results can be scrolled simultaneously. Here, in the virtual area shown in FIG. 6, the display frames (virtual display frames) 25n, 25s and 25r constituting the three types of search results transmitted from the server device 11 are positioned on lines L1, L2 and L3 extending in three directions from the center S. When the page transition the search result display page 22, the area R on the side of the center S in FIG. 6 is displayed on the monitor of the client terminal 5. The three lines L1, L2 and L3 are provided for page design presentation purposes. On each of the lines L1, L2 and L3, the three types of search results are placed. That is, each line L1, L2 and L3 is not specifically assigned to only one type of the search results. Further, the number of these lines may be other than three, or no line may be provided at all.

In the virtual area shown in FIG. 6, the results of the normal search (virtual display frame 25n) and the results of the reverse search (virtual display frame 25r) are placed in the scrolling direction in the order determined by search ranking based on the aforementioned list information. The closer to the center S the respective results of the normal search and reverse search are, the higher-ranked virtual display frames 25n and 25r are placed. The results of the serendipity search are placed in a random order using random numbers, etc. in the scrolling direction, regardless of the search ranking of plural web pages, etc. (virtual display frames 25s) included in the aforementioned list information. Further, since the results of the reverse search and the serendipity search do not correspond to the content the user is seeking to search for, it is preferable that the proportion of the virtual display frames 25r of the reverse search and the proportion of the virtual display frames 25s of the serendipity search are both relatively small with respect to the total number of virtual display frames 25n, 25r and 25s. The display frames can be placed so that the respective proportions may be, for example, 20% or less. This point also applies to the second modified example described later. In the present embodiment, as shown by arrow A in FIG. 5, the page scrolls in the direction toward or away from the front end of the monitor of the client terminal 5 (vertical direction of page). Note that in FIGS. 6 to 8, the display frames 25n and 25r for the results of the normal search and the reverse search, respectively, include parentheses indicating the search ranking.

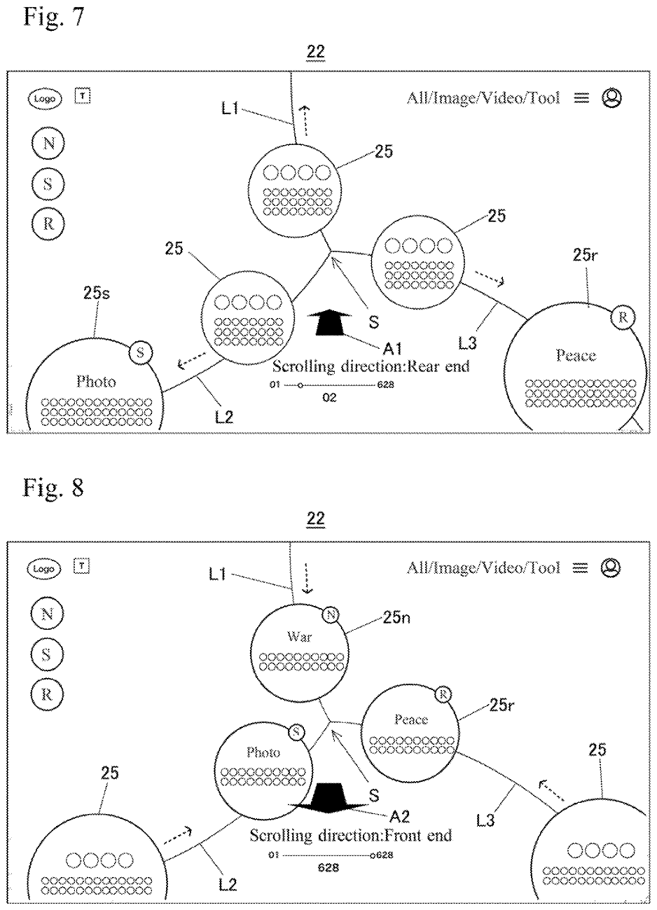

For example, when an operation is performed to advance in the scrolling direction (direction of arrow A1 in FIG. 7), on each of the lines L1, L2 and L3, the display frame 25 that was already present on the monitor at the start of the operation (hereinafter referred to as the “already-present display frame”) gradually increases in size while moving away from the center S, eventually moving outside the monitor. Meanwhile, the display frame 25 immediately outside the already-present display frame 25 in FIG. 6 newly appears from the center S side of the monitor and gradually increases in size while moving away from the center S, similarly to the already-present display frame 25. On the other hand, when an operation is performed to scroll backward (in the direction of arrow A2 in FIG. 8), on each of the lines L1, L2 and L3, the already-present display frame 25 gradually shrinks while moving closer to the center S. Once it falls below a predetermined size, it ceases to be displayed. Simultaneously, the display frame 25 immediately inside the already-present display frame 25 in FIG. 6 newly appears from outside the monitor. In the present embodiment, the display frames 25 shown on the monitor of the client terminal 5 switch by scrolling, so that three types of search results may move through a tunnel sequentially. The user can thus view the three types of search results comprehensively and simultaneously. Note that in this scrolling, with respect to the results of the normal search and the reverse search, since the lowest search-ranked display frame 25 is positioned immediately behind the top search-ranked display frame 25, by scrolling backward from the top ranked-search display frame 25, the lowest-ranked display frame 25 is displayed.

Further, the user can narrow down the three types of search results to one for viewing by page-operation of the search result display page 22. Through this page-operation, the page transitions to the narrowed-down view page 23 shown in FIG. 9. Specifically, this page-operation is the operation of dragging and dropping the display frames 25n, 25s and 25r displayed on the search result display page 22 from the lines L1, L2 and L3 onto the area outside the lines. At this time, if the display frame being dragged and dropped is the normal search frame 25n, the page transitions to a narrowed-down view page 23 in which only the normal search results are displayed. If it is a serendipity search frame 25s, the page transitions to a narrowed-down view page 23 in which only the serendipity search results are displayed. If it is a reverse search frame 25r, the page transitions to a narrowed-down view page 23 in which only the reverse search results are displayed.

On the narrowed-down view page 23, only one type of the search results from among the three types of search results selected by the user (hereinafter referred to as the “narrowed-down search results”) are displayed. On the narrowed-down view page 23, information of numerous web pages, etc. (resource) constituting the narrowed-down search results is displayed in a horizontal scrollable manner. On the narrowed-down view page 23, part or all of the information posted on each web page, etc., is displayed inside a display frame 28. Part of the posted information of web pages, etc. is displayed, for example, when the volume of the posed information on web pages, etc. exceeds the amount displayable inside the display frame 28. Further, the display frame 28, like the display frame 25, contains link information to web pages, etc. The user can access the web pages, etc., by clicking the inside of the display frame 28. Note that in the aforementioned horizontal scrolling, since the lowest search-ranked display frame 28 is positioned immediately behind the top search-ranked display frame 28, scrolling backward from the top search-ranked display frame 28 will display the lowest search-ranked display frame 28.

Here, comparing the display frame 28 of the narrowed-down view page 23 with the display frame 25 of the search result display page 22, the display frame 28 has a larger area and displays a greater volume of information. Therefore, compared with the search result display page 22, the user can select a web page that the user wishes to access while gaining a more detailed understanding of the content of each web page.

In the present embodiment, when the user performs a map transition operation, a positioning map 24 (see FIG. 10) visualizing the nature of information about the viewed web page, etc. (resource) is generated and displayed on the monitor of the client terminal 5. The map transition operation is the operation of clicking an area outside the display frame 28 on the monitor or a blank area of the display frame 28.

Here, a positioning map 24 arranges web pages, etc. (resource) in a predetermined order (such as search ranking order) or randomly with respect to a plurality (approximately 10 to 20) of pre-set information categories C (e.g., finance, construction, food, etc.). The positioning map 24 is provided with reference lines 29 for web page placement radially that are extending from the center, with each reference line 29 assigned to either one of the multiple information categories C.

The posted content of multiple web pages, etc., included in the three types of search results is analyzed based on meta information (e.g., web page owner, article theme/body, article author) to determine which of the multiple information categories C it corresponds to. Then, based on this determination, an icon 30 representing each web page, etc., is placed on the reference line 29 corresponding to the identified information category C. Note that an icon 30A representing the web page, etc. being viewed during the map transition operation is displayed distinguishably from other icons 30. In the present embodiment, only the icon 30A is colored. Note that the positioning map 24 may arrange web pages, etc., separately for each information category C. For example, the positioning map 24 may be divided vertically into multiple sections, with each section assigned an information category C to place. Part of the positioning map 24 is displayed on the monitor of the client terminal 5. Horizontal scrolling switches a displayed area (information category C).

Further, when the user performs an operation to select a specific web page (icon) 30 or a specific information category C on the positioning map 24 (by clicking the displayed portion), the page transitions to a search result display page 22 (see FIG. 4). However, the search result display page 22 shown after this transition displays only the display frames 25 for web pages 30, etc., narrowed-down to match the information category C selected by the user (or the information category C corresponding to the selected web page 30 if a web page 30 was selected).

### [Effects, etc. of the Present Embodiment]

In the present embodiment, the search engine performs two types of searches: not only a normal search that searches for related information related to the search word, but also a different aspect search that searches for different aspect information using a different word derived from the search word but having a different meaning. The search result display page 22 shown on the client terminal 5 simultaneously displays the results of the normal search and the results of the two types of different aspect searches. This allows the user of the client terminal to view not only the results of the normal search but also the results of the two types of different aspect searches, enabling the user to encounter information he might not have otherwise thought of.

### [First Modified Example of the Present Embodiment]

In the above embodiment, the search unit 11b performs a normal search, a serendipity search and a reverse search. However, it may also perform a normal search, a serendipity search and a reflection search (objective information search). That is, instead of a reverse search, a reflection search may be performed.

The reflection search is a search that promotes the user's introspective and deliberative thinking about information, providing the user with highly objective information relative to the search word. The reflection search uses plural types of databases 31 to 34 containing highly objective information. The types of databases used for the reflection search may be two or more.

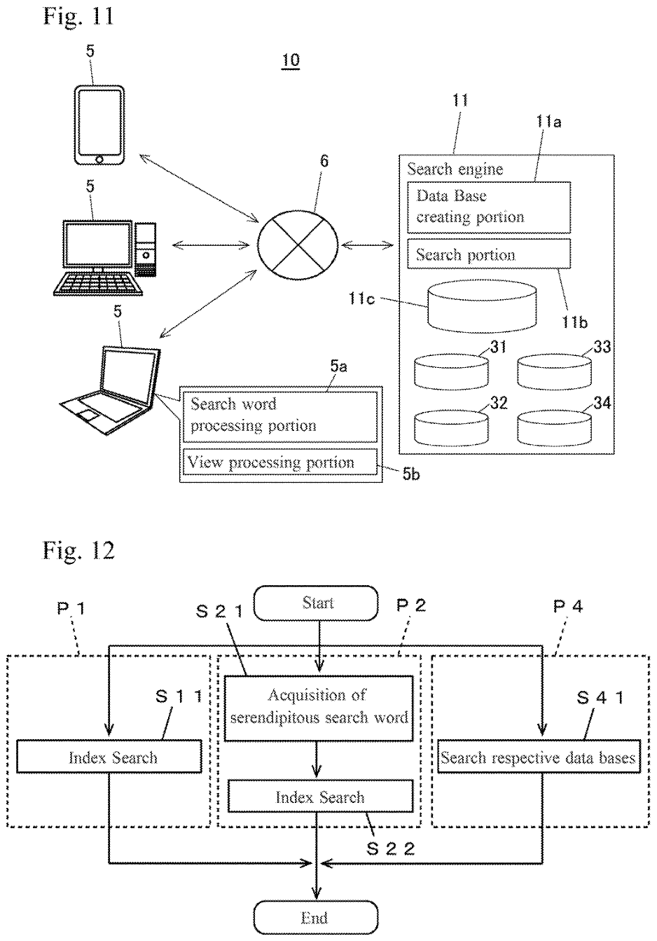

The plural types of databases 31 to 34 may include the aforementioned semantic dictionary database 31, a thesis database 32 containing numerous theses, a book database 33 containing numerous books and a newspaper article database 34 containing numerous newspaper articles (see FIG. 11). These databases 31 to 34 may be prepared by a provider offering search services via the search system 10, or may use databases generally available to the public or databases accessible only to subscribers.

FIG. 12 shows an example of a process flow of the search unit 11b. When the search unit 11b receives a search word from the client terminal 5, it starts a process flow to perform a normal search process P1, a serendipity search process P2 and a reflection search process P4 in parallel.

In the reflection search process P4, a search S41 is performed on at least two of the databases 31 to 34 of the semantic dictionary database 31, the thesis database 32, the book database 33 and the newspaper article database 34, using a search word. A set of search results obtained from the at least two databases 31 to 34 constitutes the results of the reflection search. In this modified example, the search S41 is performed on each of the databases 31 to 34 using a search word. The set of search results obtained from the plural databases 31 to 34 constitutes the reflection search results. On the search result display page 22, the results of the normal search, the serendipity search and the reflection search are then displayed simultaneously. In FIGS. 5-8 , the reference sign 25r corresponds to the results of the reflection search.

Note that since the reverse search uses a different word having a different meaning from the search word, it is equivalent to the second type of different aspect search, while the reflection search using a search word directly is not equivalent to the second type of different aspect search. However, the reflection search may perform a search on two or more databases 31 to 34, using a different word derived from the search word but having a different meaning, instead of using the search word directly. In this case, as an example of a different word, if the search word is “Tesla,” the semantic dictionary database 31 can be used to derive the different word ‘automobile’ or “EV.”

Note that the search unit 11b is configured to perform three types of searches of a normal search, a serendipity search, and a reverse search. When no reverse search results are available, the reflection search may be performed.

### [Second Modified Example of the Present Embodiment]

This modified example differs from the above embodiment in the monitor display of the client terminal 5 and other aspects. The monitor display of the client terminal 5 transitions based on the processing of a client-specific program or a program operating on a web browser.

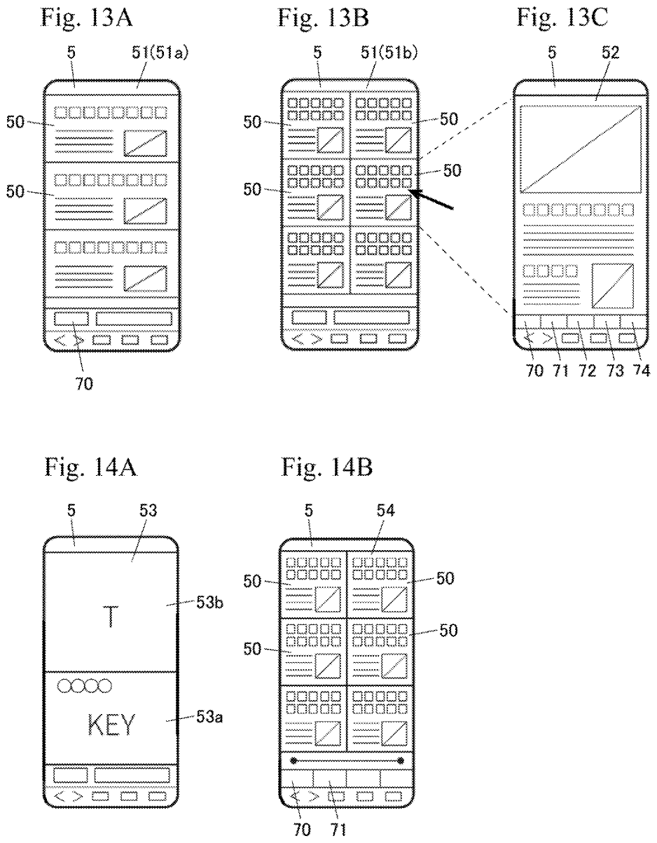

Specifically, on the client terminal 5, when the client-specific program is launched, after the opening page, a latest information display page 51 shown in FIGS. 13A and 13B is displayed. The latest information display page 51 is the page that displays information about resources such as respective web pages, etc. collected by a crawler (search robot) during its most recent crawling. On the latest information display page 51, information about each resource is displayed in a tile-shaped display portion 50, each enclosed by a frame of a predetermined shape.

On the latest information display page 51, the tile-shaped display portions 50 are arranged at least vertically. The latest information display page 51 allows adjustment of the number of display columns of the tile-shaped display portions 50 in the monitor by zooming in or out operations such as pinch-in or pinch-out. FIG. 13A shows the latest information display page 51a with a single display column, and FIG. 13B shows the latest information display page 51b with two display columns. In the case of multi display columns, the tile-shaped display portions 50 are respectively arranged both vertically and horizontally. On the latest information display page 51, unless the user performs a scroll stop operation (e.g., continuously clicking on an arbitrary position on the monitor), the tile-shaped display portions 50 in the monitor automatically scroll downwards from top to bottom. On the latest information display page 51, information about resources collected during the most recent crawling streams in a predetermined order.

On the latest information display page 51, when a tile-shaped display portion 50 (the tile-shaped display portion 50 indicated by the arrow) is selected by clicking, as shown in FIG. 13C, the selected tile-shaped display portion 50 is gradually enlarged and switches to a resource display page 52 (such as a web page) for viewing or otherwise the resource corresponding to the tile-shaped display portion 50. On the resource display page 52, the user can view or watch the web page, etc.

At the bottom of the latest information display page 51, as a standby menu selecting portion, a home button 70 for switching to a search word entering page 53, a URL (uniform resource locator) entering portion, etc. are provided. Further, as a common menu selecting portion, a process view button (button for transitioning to previously or subsequently viewed pages), an output button for sharing or printing, etc. are provided. The standby menu selecting portion and the common menu selecting portion are also provided on the search word entering page 53 shown in FIG. 14A.

When the home button 70 is operated on the latest information display page 51, the search word processing unit 5a displays a search word entering page 53 shown in FIG. 14A. On the entering page 53, a keyboard is displayed on the lower area 53a, and the search word entered via the keyboard is displayed on the upper area 53b. Then, when the user of the client terminal 5 performs operations of entering the search word and executing the search, the search word processing unit 5a accepts the user's search executing operation and transmits the search word entered in the entering page 53 to the server device 11.

At the server device 11, when a search word (search query) arrives, processing of the search unit 11b (search engine processing) is executed. Regarding the processing of the search unit 11b, the search unit 11b starts the process flow of the same flowchart as the first modified example (the flowchart in FIG. 12). It performs a process P1 of a normal search, a process P2 of a serendipity search and a process P4 of a reflection search in parallel, thereby obtaining the search results of the respective searches. It then outputs the respective search results to the client terminal 5 that transmitted the search word. The respective search results include list information (list information about resources) such as web pages for each of the three types of search results. Note that the search unit 11b may perform a reverse search process P3 (see the flowchart in FIG. 3) instead of the reflection search process P4.

The client terminal 5 receives transmission information containing the respective search results from the server device 11. Then, the view processing unit 5b displays a search result display page 54 shown in FIG. 14B. The search result display page 54 simultaneously displays the three types of search results mentioned above (results of the normal search, results of the serendipity search and results of the reflection search). For at least the results of the normal search and the results of the reflection search among these three types of search results, the aforementioned list information includes search ranking information.

On the search result display page 54, as shown in FIG. 14B, resource information of the respective search results is displayed in the tile-shaped display portions 50 each enclosed by a frame of a predetermined shape, similarly to the latest information display page 51. The search result display page 54 allows adjustment of the number of display columns of the tile-shaped display portions 50 on the monitor by zooming in or out operations such as pinch-in or pinch-out. By clicking one of the plural tile-shaped display portions 50 displayed on the monitor, the selected tile display section 50 is gradually enlarged and switches to the aforementioned resource display page 52 (see FIG. 13C). When an operation to select one from plural web pages is performed on the client terminal 5, the content of the selected web page is displayed on the resource display page 52 for viewing.

On the search result display page 54, the three types of search results transmitted from the server device 11 are arranged, for example, in a random proportion. When viewing only the results of the normal search from among them, the tile-shaped display portion 50 corresponding to the normal search results are arranged in the scrolling direction in the order determined by search ranking, for example, based on list information. When viewing only the reflection search results, the tile-shaped display portion 50 corresponding to the reflection search results are arranged in the scrolling direction in the order determined by search ranking, for example based on list information. On the other hand, when viewing only the serendipity search results, the tile-shaped display portion 50 corresponding to the serendipity search results are arranged in the scrolling direction in a random order using random numbers, etc. regardless of search ranking. Further, since the results of the three types of searches are displayed in the tile-shaped display portions 50 of the same size and shape on the search result display page 54, the aforementioned identification information 26 may be added, or display methods such as color or font of the tile-shaped display portions 50 may be differentiated between the three types of searches so that the user can distinguish which search produced which results.

The search result display page 54 also includes a list menu selecting portion comprising a home button 70, a comparison mode selecting button 71, a resource classification button and a search type classification button. The resource classification button allows the user to narrow down the search results to be displayed on the search result display page 54 from among texts, images, videos, time periods, languages, files, and news. The search type classification button allows the user to narrow down the search results displayed on the search result display page 54 from among the search results of a normal search, a serendipity search and a reflection search.

In this modified example, the modes (menus) selectable by the user include a comparison mode, a horizontal expansion mode, a concrete-abstract mode and a site information display mode. The resource display page 52 is provided, as a content menu selecting portion, with a home button 70, a comparison mode selecting button 71, a horizontal expansion mode selecting button 72, a concrete-abstract mode selecting button 73 and a site information display mode selecting button 74 (see FIG. 13C). The comparison mode is accessible from both the search result display page 54 and the resource display page 52. The horizontal expansion mode, the concrete-abstract mode and the site information display mode can be accessed from the resource display page 52.

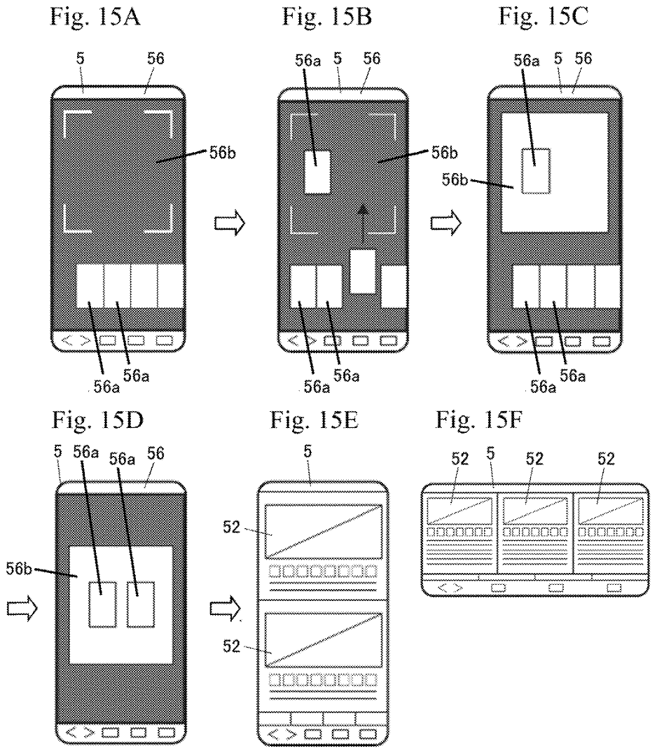

Selecting the comparison mode selecting button 71 on the search result display page 54 or the resource display page 52 a page switches to the comparative-viewing preparation page 56 shown in FIG. 15A. On the comparative-viewing preparation page 56, comparison tiles (icons) 56a for plural web pages viewed on the client terminal 5 are displayed to be arranged in a predetermined order. For example, at the bottom of the comparative-viewing preparation page 56, comparison tiles 56a displaying scripts (such as titles) for grasping the content of already viewed resources (e.g., web pages), based on the user's view history information, are arranged horizontally (in this example, from left to right) in the order of the shortest elapsed time since being viewed. The tile columns 56a, 56a containing plural comparison tiles 56a can be scrolled horizontally. For example, scrolling leftward causes the left side comparison tile 56a to move outside the monitor, and a new comparison tile 56a appears from the right side.

When an operation is performed to select plural comparison tiles 56a as part of the plural comparison tiles 56a for plural web pages, the web pages of the selected plural comparison tiles 56a are viewably displayed side-by-side vertically or horizontally. For example, a drag space 56b for selecting a comparison tile 56 is provided at the top 56b of the comparative-viewing preparation page 56. As shown in FIGS. 15B and 15C, when a user selects one comparison tile 56a from the tile columns 56a, 56a and moves the selected comparison tile 56a by a moving operation (via drag, swipe, flick, etc.) to the tiles 56a to the drag space 56b, the comparison tile 56a remains in the drag space 56b.

When a predetermined comparison executing operation is performed in the state where two or more comparison tiles 56a are present in the drag space 56b due to this moving operation (see FIG. 15D), each comparison tile 56a in the drag space 56b is enlarged and switches to a resource display page 52, as shown in FIG. 15E, and plural resource display pages 52 are then displayed simultaneously on the monitor. The plural resource display pages 52 are displayed without overlapping and are substantially of the same size. When the client terminal 5 is in portrait orientation, the resource display pages 52 are arranged vertically, as shown in FIG. 15E. When the client terminal 5 is in landscape orientation, the resource display pages 52 are arranged horizontally, as shown in FIG. 15F. By viewing each resource display page 52, it becomes possible to compare their contents.

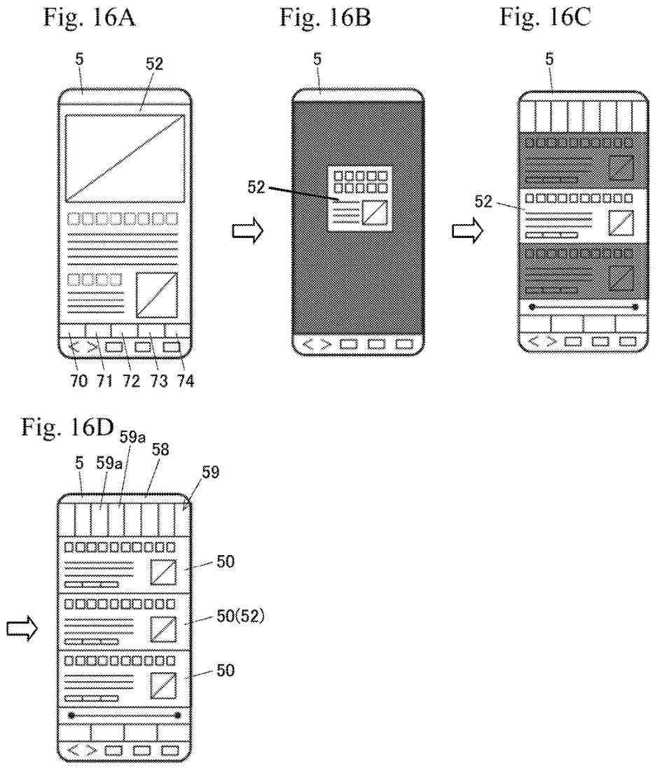

Next, pressing the horizontal expansion mode selecting button 72 on the resource display page 52 shown in FIG. 16A executes a search to obtain categorized Internet information. Then, after passing through a presentation pages (FIG. 16B, FIG. 16C) where the resource display page 52 gradually shrinks, the page switches to a second search result display page 58 shown in FIG. 16D. On the second search result display page 58, search results are arranged by category.

Specifically, the plural categories displayed on the second search result display page 58 are divided into a first group and a second group. The first group includes plural (eight in this modified example) categories (e.g., clothing, food, housing, health, play, work, learning and feeling). The second group includes plural (four in this modified example) categories (e.g., lifestyle, economy, society and nature). The categories belonging to the first group are arranged the horizontal direction with respect to the display orientation of the monitor, including areas outside the monitor. The categories belonging to the second group are arranged vertically, including areas outside the monitor, relative to the monitor's display orientation. Note that to achieve the display of the second search result display page 58, each resource collected during crawling is tagged with one category from the first group and one category from the second group, respectively.

The second search result display page 58 is provided with a category switching portion 59 for switching a viewing target category in the first group. In the category switching portion 59, plural buttons 59a displaying the titles of the respective categories belonging to the first group are arranged horizontally. By operating one button 59a from among the plural buttons 59a, a category to be displayed on the monitor can be selected from the first group. Further, regarding the second group, a predetermined number of resources are arranged vertically for each of the four categories and resource groups consisting of a predetermined number of resources are arranged in the order of life, economy, society and nature. For example, if the predetermined number is 10, then 10 “Life” resource groups, 10 “Economy” resource groups, 10 ‘Society’ resource groups and 10 “Nature” resource groups are arranged vertically. The user can switch the category to be displayed on the monitor from the second group by vertically scrolling.

When transitioning to the second search result display page 58, the tile-shaped display portions 50 are arranged centrally around the respective categories of the first and second groups tagged to the resources on the resource display page 52 (hereinafter referred to as the “operation page”) when the horizontal expansion mode selecting button 72 is pressed. At this time, the tile-shaped display portion 50 representing the operation page 52 is positioned near the center of the monitor. For example, if the resource on the operation page 52 is tagged with the “Clothing” category from the first group and the ‘Nature’ category from the second group, the tile-shaped display portions 50 of the resource tagged with the “Clothing” category are arranged on the monitor. Vertically, the tile-shaped display portions 50 of resource groups, etc. tagged with “Nature” are arranged centered around the operation page 52. If the operation page 52 is positioned on the edge of the resource group tagged with “Nature,” the tile-shaped display portion 50 of an adjacent resource group is also displayed.

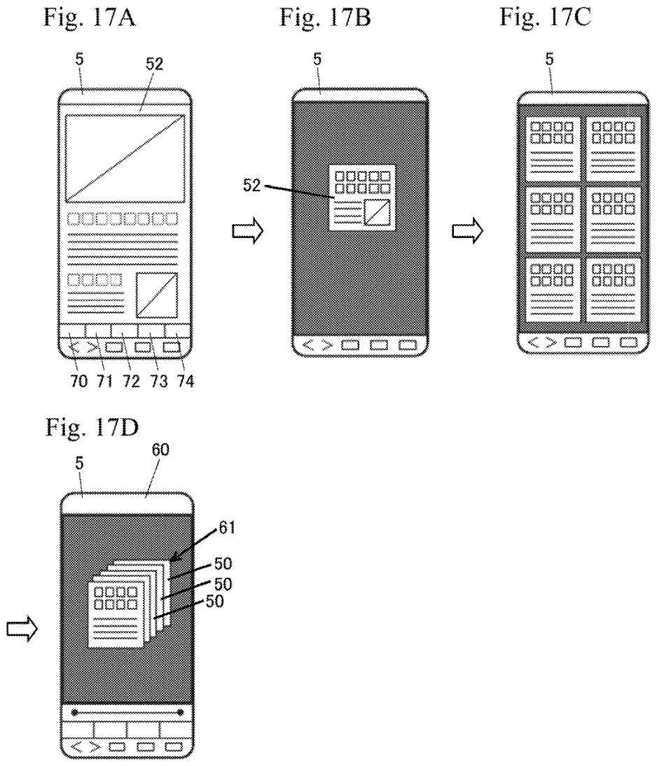

Next, when the abstract-concrete mode selecting button 73 is pressed on the resource display page 52 shown in FIG. 17A (in the state where the web page is viewably displayed on the client terminal 5, an operation to select the concrete-abstract mode is performed on the client terminal 5), an abstract-concrete search is executed to obtain concrete information and small-to-medium information. The abstract-concrete search is configured to perform an abstract search using an abstract word and a concrete search using a concrete word by automatically acquiring an abstract word obtained by higher-level conceptualizing a target word and a concrete word obtained by lower-level conceptualizing the target word or an abstract word, using a word related to the web page viewably displayed as a target word. For example, in addition to a normal search using the entered search word (the most recent search word entered by the user) used to reach the resource display page 52 when the abstract-concrete mode selecting button 73 is pressed, a normal search is performed using an automatically acquired search word (abstract words, concrete words) obtained by higher-level or lower-level conceptualizing mainly the search word in the abstract-concrete direction of language. The automatically acquired search word may be one or plural. If plural, a normal search is performed for each automatically acquired search word (abstract word concrete word).

For example, by executing a normal search with each of a first automatically acquired search word (which may be abstracted at two or more levels) as an abstract word obtained by higher-level conceptualizing the entered search word and a second automatically acquired search word as a concrete word obtained by lower-level conceptualizing the higher-level conceptualized word in addition to the entered search word, abstract search results and concrete search results can be obtained step-by-step. Note that in searches using each of the plural search words (hereinafter referred to as “used search words”) composed of the entered search word and the automatically acquired search words, serendipity searches and reflection searches (or reverse searches) may be performed in addition to the normal search.

By analyzing the content described on the resource display page 52 at the time when the abstract-concrete mode selecting button 73 is pressed contextually through artificial intelligence, a word obtained by higher-level conceptualizing (or lower-level conceptualizing) the description may also be used as an automatically acquired search word. For example, if an article about an automobile is described on the resource display page 52, “means of transportation” is acquired as an automatically acquired search word.

Regarding the abstract-concrete search, in the client terminal 5, search results of the abstract search and the concrete search are arranged and displayed in the sequential order starting with search results using a search word having a high level of abstraction (or a search word having a high level of concreteness). For example, in the abstract-concrete search, results by plural used search words are gathered and arranged in the sequential order according to the level of abstraction-concreteness of the used search words. Pressing the abstract-concrete mode selecting button 73 the page switches to the third search result display page 60 shown in FIG. 17 after presentation pages (FIG. 17B, FIG. 17C). On a third search result display page 60, search results using a used search word having a high level of abstraction to search results using a used search word having a high level of concreteness are displayed step-by-step. On the third search result display page 60, an assembly 61 of the tile-shaped display portions 50 on which resource information is displayed corresponding to each search result by plural used search words. In the assembly 61, plural tile-shaped display portions 50 are arranged sequentially according to the abstract-to-concrete level of the used search words. For example, in the assembly 61, search results using a used search word having a higher level of abstraction are placed toward the rear end, while search results using a used search word having a higher level of concreteness are placed toward the front end.

When a user selects one tile-shaped display portion 50, the tile-shaped display portion 50 switches to the resource display page 52. The user can then view the content displayed on the resource display page 52 by scrolling the page vertically. By scrolling the page horizontally, the tile-shaped display portion 50 adjacent to the selected tile in the abstract-to-concrete direction in the assembly 61 switches to the resource display page 52. By navigating through the information in the assembly 61, the user can view abstract or concrete search results.

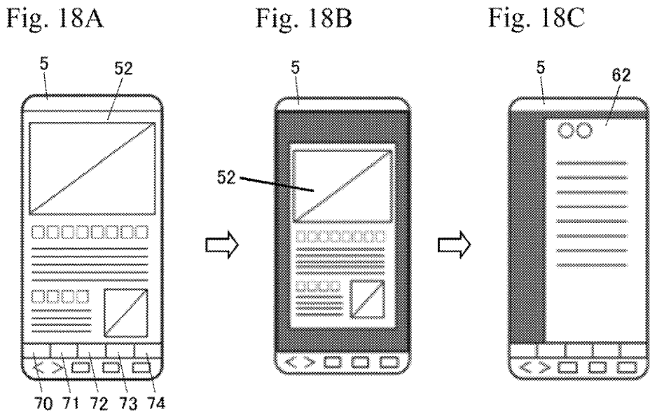

Next, pressing the site information display mode selecting button 74 on the resource display page 52 shown in FIG. 18A causes the page to transition through the presentation page shown in FIG. 18B and switch to the site information display page 62 shown in FIG. 18C. On the site information display page 62, the URL, SSL certificate, domain classification (e.g., public or private site), page title, page summary, publication date, and viewing caution level (e.g., whether the site is dangerous) are described as site information, with respect to the resource display page 52 at the time when the site information display mode selecting button 74 was pressed.

The present modified example is provided with a comparison mode, a horizontal expansion mode and a concrete-abstract mode as useful modes for scrutinizing information. The comparison mode allows users to grasp commonalities and differences in search results, facilitating information scrutiny. The horizontal expansion mode enables users to understand search targets from multiple perspectives, thereby broadening application horizons. The concrete-abstract mode helps users understand the structure and relationships of things, revealing their essence. Further, by performing the most possible bias-less searches, it is possible to obtain flat information that avoids filter bubbles and personalization. Further, the reflection search enables acquisition of objective information to promote introspective and deliberative thinking about information. Moreover, the serendipity search yields information derived from randomness and analogy, reproducing unexpected and unforeseen information.

### [Other Embodiments]

In the above embodiment, two types of different aspect searches (serendipity search, reverse search) are performed, but either one search may be performed alongside the normal search.

In the above embodiment, the search result display page 22 may divide the page area into three sections horizontally or vertically, displaying the three types of search results separately in these three sections. In this case, the three types of search results may be scrollable simultaneously or individually.

In the above embodiment, the results of the serendipity search may also be arranged in the virtual area shown in FIG. 6, based on the above list information, in the order determined by the search ranking relative in the scroll direction.

In the above embodiment, in the process of accepting search words from the client terminal 5, search words entered into the input screen 21 are accepted. However, the search system and the client program may be configured to accept search words issued by the user of the client terminal 5.

### INDUSTRIAL APPLICABILITY

The present invention is applicable to a search system, etc. used for searching information on the Internet.

### DESCRIPTION OF REFERENCE CHARACTERS

5 Client terminal
6 Internet
10 Search system
11 Server device
21 Entering page
22 Search result display page
23 Narrowed-down view page
24 Positioning map

1. A search system comprising:
a search engine provided in a server device; and
a view processing portion provided in a client terminal,
wherein the search engine is configured to perform searches when a search word is received at the server device from the client terminal via the Internet;
wherein when results of the searches by the search engine are received at the client terminal, the view processing portion causes the client terminal to display a search result display page for displaying the results of the searches;
wherein the search engine is configured to perform at least a normal search that searches for related information related to the search word and a different aspect search that searches for different aspect information related to a different word derived from the search word, the different word having a meaning different from the search word; and
wherein the view processing portion causes the client terminal to simultaneously display the results of the normal search and the results of the different aspect search on the search result display page.

2. The search system according to claim 1, wherein the different aspect search is a serendipity search that searches for serendipity information that a user of the client terminal perceives as serendipitous, using a serendipity-search obtained based on a related word related to the search word as the different word;
wherein the search engine is configured to perform, in addition to the normal search and the serendipity search, an objective information search that searches at least two or more databases from among a semantic dictionary database, a thesis database, a book database and a newspaper article database, using the search word; and
wherein the results of the normal search, the results of the serendipity search and the results of the objective information search are simultaneously displayed on the search result display page.

3. The search system according to claim 1, wherein information of plural web pages as the respective search results of the normal search and the different aspect search are displayed on the search result display page;
wherein when an operation is performed on the client terminal to select one of the plural web pages, the selected web page is viewably displayed on the client terminal;
wherein when an operation is performed on the client terminal to select a comparison mode, icons of plural web pages viewed on the client terminal are arranged and displayed in a predetermined order on the client terminal; and
wherein when an operation is performed to select the plurality of icons as part of the icons of the plural web pages, the web pages of the selected plural icons are viewably displayed side-by-side vertically or horizontally.

4. The search system according to claim 1, wherein information of plural web pages as the respective search results of the normal search and the different aspect search are displayed on the search result display page;
wherein when an operation is performed on the client terminal to select one of the plural web pages, the selected web page is viewably displayed on the client terminal;
wherein, in a state where the web page is viewably displayed on the client terminal, when an operation to select a concreteness-abstraction mode is performed on the client terminal, the system is configured to automatically acquire an abstract word and a concrete word by using a target word which is a word related to the web page viewably displayed and perform an abstract search using the abstract word and a concrete search using the concrete word, the abstract word is obtained by higher-level conceptualizing the target word and the concrete word is obtained by lower-level conceptualizing the target word; and
wherein the search results of the abstract search and the search results of the concrete search are arranged and displayed on the client terminal in an order of an abstractness of the search word.

5. The search system according to claim 2, wherein identification information is displayed on the search result display page to enable the user of the client terminal to distinguish between the results of the normal search, the results of the serendipity search and the results of the objective information search.

6. The search system according to claim 2, wherein when a scrolling operation is performed on the search result display page, the results of the normal search, the results of the serendipity search and the results of the objective information search scroll simultaneously.

7. The search system according to claim 2, wherein a selecting operation is possible to narrow down plural types of search results, including the results of the normal search, the results of the serendipity search and the results of the objective information search to one type of search results for viewing on the search result display page; and
wherein when the selecting operation is performed, a narrowed-down view page displaying only the one type of search results selected by the selecting operation from among the plural types of search results is displayed on the client terminal.

8. A non-transitory computer-readable information storage medium storing a search program for causing a computer of a server device to:
perform, as an operation of a search engine, at least a normal search that searches for information related to a search word and a different aspect search that searches for different aspect information related to a different word derived from the search word, when the search word is received at the server device from a client terminal, the different word having a meaning different from the search word; and
transmit information containing results of the normal search and results of the different aspect search to the client terminal that transmitted the search word.

9. A non-transitory computer-readable information storage medium storing a program for causing a computer of a client terminal to:
transmit a search word received from a user of the client terminal to a server device where a search engine operates; and
transition a monitor display of the client terminal to a search result display page simultaneously displaying results of a normal search composed of related information related to the search word and results of a different aspect search composed of different aspect information related to a different word derived from the search word, when information containing the results of the normal search and the results of the different aspect search are received at the client terminal from the server device, the different word having a meaning different from the search word.
